(19) United States
(12) Patent Application Publication
(10) Pub. No.: US 2005/0014121 A1
(43) Pub. Date: Jan. 20, 2005

(54) Integrating an external course into an electronic learning system

(76) Inventors: Hagen Eck, Heidelberg (DE); Marcus Philipp, Dielheim (DE)

Correspondence Address: FISH & RICHARDSON, P.C., 3300 DAIN RAUSCHER PLAZA, 60 SOUTH SIXTH STREET, MINNEAPOLIS, MN, 55402, US

(21) Appl. No.: 10/619,756

(22) Filed: Jul. 15, 2003

(51) Int. Cl. G09B 3/00

(52) U.S. Cl. 434/350

(57) ABSTRACT

An electronic learning system (ELS) provides access to an electronic course that is hosted by an external system that is not part of the ELS. The ELS includes a front end that exchanges communications with the external system to obtain access to the electronic course, a learning portal that runs software to view the electronic course, and a back end that stores information that relates to the electronic course.

### TECHNICAL FIELD

This application relates generally to integrating an electronic course into an electronic learning system (ELS) and, more particularly, to integrating into the ELS an electronic course hosted by a system external to the ELS.

### BACKGROUND

Systems and applications for delivering computer-based training (CBT) have existed for many years. However, CBT systems historically have not gained wide acceptance. A problem hindering the reception of CBTs as a means of training workers and users is compatibility between systems. A CBT system works as a stand-alone system that is unable to use content designed for use with other CBT systems.

With the advent of the World Wide Web (WWW), the foregoing drawback of conventional CBT systems has become more pronounced. In particular, Web-based CBT users now have ready access to a wide range of electronic courses. CBT users, however, have been unable to take full advantage of the increasing availability of electronic courses due to the inability of existing CBT systems to share content.

### SUMMARY

In general, in one aspect, the invention is directed to an electronic learning system (ELS) that provides access to an electronic course that is hosted by an external system that is not part of the ELS. The ELS includes a front end that exchanges communications with the external system to obtain access to the electronic course, a learning portal that runs software to view the electronic course, and a back end that stores information that relates to the electronic course. This aspect may include one or more of the following features.

The communications may include a register command that is transmitted from the front end to the external system to register a user of the ELS with the external system; an enroll command that is transmitted from the front end to the external system to enroll a user of the ELS in the electronic course; a launch command that is transmitted from the front end to the external system to start the electronic course; and/or a track command that is transmitted from the front end to the external system to track user activity vis-à-vis the electronic course.

The communications may also include a response that is transmitted from the external system to the front end following receipt of the track command by the external system. The response may include one or more of the following: a percentage of material from the electronic course that has been viewed, a test score associated with material from the electronic course, and an amount of time spent viewing material in the electronic course.

The communications may include commands transmitted from the ELS to the external system and replies from the external system to the ELS. The commands may be transmitted in accordance with simple object access protocol (SOAP).

The information stored by the back end may include metadata. The back end may obtain the metadata from the external system. The metadata may include a course catalog for the electronic course. The course catalog may contain a description of material in the electronic course.

The learning portal, the front end, and the back end may be implemented on a single computer or other type of machine. The learning portal, the front end, and the back end may be implemented on multiple computers or other types of machines.

In general, in another aspect, the invention is directed to an ELS that incorporates an electronic course that is hosted by an external system that is not part of the ELS. The ELS of this aspect includes a front end that issues commands to the external system to obtain access to the electronic course. The commands include a register command to register with the external system, an enroll command to enroll in the electronic course, and a launch command to launch the electronic course. This aspect of the ELS may include one or more of the following features.

The commands may include a track command to track progress with respect to the electronic course. The front end may receive a response to the track command. The response may include a percentage of material from the electronic course that has been viewed, a test score associated with material from the electronic course, and an amount of time spent viewing material in the electronic course.

The ELS may include a back end that retrieves metadata from the external system and that updates a course catalog using the metadata. The course catalog may include a description of material associated with the electronic course.

The commands may be transmitted in accordance with SOAP. The ELS may access the external system over a network. The commands may be sent from the ELS to the external system over the network. The network may include the Internet.

In general, in another aspect, the invention is directed to an ELS that includes a front end to mediate access to an electronic course that is hosted by an external system that is not part of the ELS. The front end interacts with the external system through a series of commands that contain identification and control information for use by the external system. The front end receives responses to the commands including a response relating to progress through the electronic course. The ELS also includes a back end to maintain information on the ELS about the electronic course. This aspect may include one or more of the following features.

The back end may obtain metadata from the external system. The metadata may contain a description of information in the electronic course. The back end may store the metadata in memory on the ELS. The ELS may include a learning portal that runs a Web browser to present the electronic course.

The commands may include one or more of the following: a register command that is transmitted from the front end to the external system to register a user of the ELS with the external system; an enroll command that is transmitted from the front end to the external system to enroll a user of the ELS in the electronic course; a launch command that is transmitted from the front end to the external system to start the electronic course; and a track command that is transmitted from the front end to the external system to track user activity vis-à-vis the electronic course. The commands may be transmitted according to SOAP.

In general, in another aspect, the invention is directed to a machine-readable medium that stores,executable instructions to access, via an ELS, an electronic course hosted by an external system that is not part of the ELS. The instructions cause a machine to communicate with the external system via a series of commands to register with the external system, enroll in the electronic course, and launch the electronic course. The machine maintains a database of information associated with the electronic course. This aspect may include one or more of the following features.

The commands may include a track command to track progress through the electronic course. The commands may be transmitted in accordance with SOAP. Maintaining the database of information may include receiving metadata from the electronic course, and updating the database in accordance with the metadata. The database may include a course catalog that includes information about the electronic course. Maintaining the database of information may include storing information about the external system.

Communicating with the external system may include receiving responses to the commands. At least one of the responses may include one or more of the following: a percentage of material from the electronic course that has been viewed, a test score associated with material from the electronic course, and an amount of time spent viewing material in the,electronic course.

In general, in another aspect, the invention is directed to an ELS that provides access to an electronic course that is hosted by an external system that is not part of the ELS. The ELS includes means for exchanging communications with the external system to obtain access to the electronic course, means for presenting the electronic course, and means for collecting information that relates to the electronic course. This aspect may include one or more of the following features.

The means for exchanging may include one or more servers to mediate access to the electronic course. The one or more servers may exchange communications with the external system through a series of commands that contain identification and control information for use by the external system. The one or more servers may receive responses to the commands. The responses may include a response relating to progress through the electronic course and a response providing the ELS with access to the electronic course.

In general, in another aspect, the invention is directed to a network that includes a first ELS that hosts an electronic course, and a second ELS that accesses the electronic course over a network via a series of commands and responses. The series of commands and responses may include a register command transmitted from the second ELS to the first ELS to register with the first ELS, an enroll command transmitted from the second ELS to the first ELS to enroll in the electronic course, a launch command transmitted from the second ELS to the first ELS to launch the electronic course, and a response to the launch command.

The response is transmitted from the first ELS to the second ELS following receipt of the launch command by the first ELS. The response makes material from the electronic course accessible to the second ELS. The response may be a hypertext transfer protocol (HTTP) command that directs the second ELS to the material, and/or a uniform resource locator (URL) that can be used to link to the material.

Other features and advantages will be apparent from the description, the drawings, and the claims.

### DESCRIPTION OF THE DRAWINGS

FIG. 1 is an exemplary content aggregation model.

FIG. 2 is an example of an ontology of knowledge types.

FIG. 3 is an example of a course graph for electronic learning.

FIG. 4 is an example of a sub-course graph for electronic learning.

FIG. 5 is an example of a learning unit graph for electronic learning.

FIG. 6 is a block diagram of an ELS.

FIG. 7 is functional diagram of the ELS.

FIG. 8 is a flowchart showing a process used by the ELS to access a course hosted on an external system.

Like reference numerals in different figures indicate like elements.

### DETAILED DESCRIPTION

Course Content and Structure

The ELS and methodology described herein structures course material (i.e., content) so that the content is reusable and flexible. For example, the content structure allows the creator of a course to reuse existing content to create new or additional courses. In addition, the content structure provides flexible content delivery that may be adapted to the learning styles of different users.

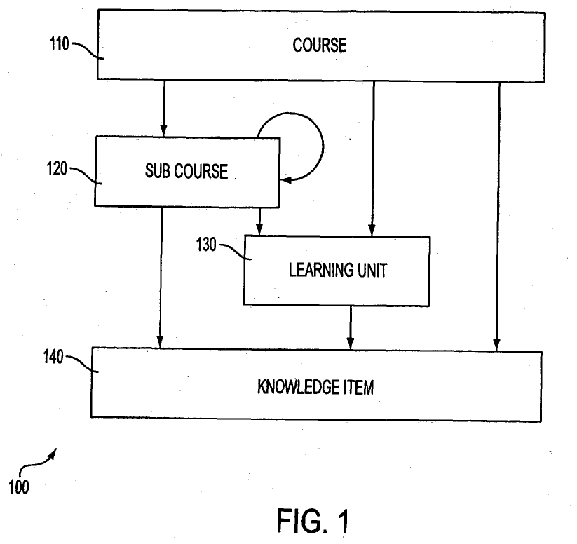

Electronic learning content may be aggregated using a number of structural elements arranged at different aggregation levels. Each higher-level structural element may refer to any instances of all structural elements of a lower level. At its lowest level, a structural element refers to content and is not further divided. According to one implementation shown in FIG. 1, course material 100 may be divided into four structural elements: a course 110, a sub-course 120, a learning unit 130, and a knowledge item 140.

Starting from the lowest level, knowledge items 140 are the basis for the other structural elements and are the building blocks of the course content structure. Each knowledge item 140 may include content that illustrates, explains, practices, or tests an aspect of a thematic area or topic. Knowledge items 140 typically are small in size (i.e., of short duration, e.g., approximately five minutes or less).

A number of attributes may be used to describe a knowledge item 140, such as, for example, a name, a type of media, and a type of knowledge. The name may be used by a learning system to identify and locate the content associated with a knowledge item 140. The type of media describes the form of the content that is associated with the knowledge item 140. For example, media types include a presentation type, a communication type, and an interactive type. A presentation media type may include a text, a table, an illustration, a graphic, an image, an animation, an audio clip, and/or a video clip. A communication media type may include a chat session, a group (e.g., a newsgroup, a team, a class, and a group of peers), an email, a short message service (SMS), and an instant message. An interactive media type may include a computer based training, a simulation, and a test.

A knowledge item 140 also may be described by the attribute of knowledge type. For example, knowledge types include knowledge of orientation, knowledge of action, knowledge of explanation, and knowledge of source/reference. Knowledge types may differ in learning goal and content. For example, knowledge of orientation offers a point of reference to the user, and, therefore, provides general information for a better understanding of the structure of interrelated structural elements. Each of the knowledge types is described in further detail below.

Knowledge items 140 may be generated using a wide range of technologies. In one embodiment, a browser (including plug-in applications) interprets and displays the appropriate file formats associated with each knowledge item. For example, markup languages (such as a Hypertext Markup language (HTML), a standard generalized markup language (SGML), a dynamic HTML (DHTML), or an extensible markup language (XML)), JavaScript (a client-side scripting language), and/or Flash may be used to create knowledge items 140.

HTML may be used to describe the logical elements and presentation of a document, such as, for example, text, headings, paragraphs, lists, tables, or image references.

Flash may be used as a file format for Flash movies and as a plug-in for playing Flash files in a browser. For example, Flash movies using vector and bitmap graphics, animations, transparencies, transitions, MP3 audio files, input forms, and interactions may be used. In addition, Flash allows a pixel-precise positioning of graphical elements to generate impressive and interactive applications for presentation of course material to a user.

Learning units 130 may be assembled using one or more knowledge items 140 to represent, for example, a distinct, thematically-coherent unit. Consequently, learning units 130 may be considered containers for knowledge items 140 of the same topic. Learning units 130 also may be considered relatively small in size (i.e., duration) though larger than a knowledge item 140.

Sub-courses 120 may be assembled using other sub-courses 120, learning units 130, and/or knowledge items 140. The sub-course 120 may be used to split up an extensive course into several smaller subordinate courses. Sub-courses 120 may be used to build an arbitrarily deep nested structure by referring to other sub-courses 120.

Courses may be assembled from all of the subordinate structural elements including sub-courses 120, learning units 130, and knowledge items 140. To foster maximum reuse, all structural elements may be self-contained and context free.

Structural elements also may be tagged with metadata that is used to support adaptive delivery, reusability, and search/retrieval of content associated with the structural elements. For example, learning objective metadata (LOM) defined by the IEEE “Learning Object Metadata Working Group” may be attached to individual course structure elements.

A learning objective corresponds to information that is to be imparted by an electronic course, or a structural element thereof, to a user taking the electronic course. The learning objective metadata noted above may represent numerical identifiers that correspond to learning objectives. The metadata may be used to configure an electronic course based on whether a user has met learning objectives associated with structural element(s) that make up the course.

Other metadata may relate to a number of knowledge types (e.g., orientation, action, explanation, and resources) that may be used to categorize structural elements.

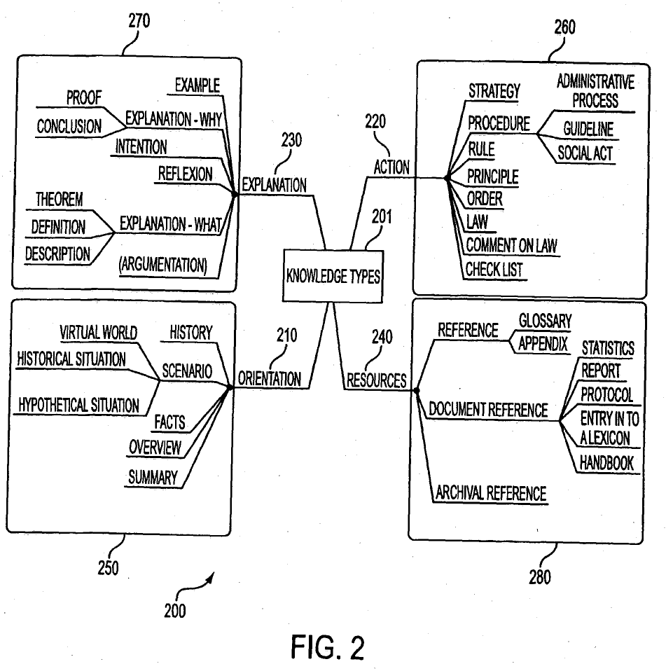

As shown in FIG. 2, structural elements may be categorized using a didactical ontology 200 of knowledge types 201 that includes orientation knowledge 210, action knowledge 220, explanation knowledge 230, and resource knowledge 240. Orientation knowledge 210 helps a user to find their way through a topic without acting in a topic-specific manner and may be referred to as “know what”. Action knowledge 220 helps a user to acquire topic related skills and may be referred to as “know how”. Explanation knowledge 230 provides a user with an explanation of why something is the way it is and may be referred to as “know why”. Resource knowledge 240 teaches a user where to find additional information on a specific topic and may be referred to as “know where”.

The four knowledge types (orientation, action, explanation, and resource) may be further divided into a fine grained ontology as shown in FIG. 2. For example, orientation knowledge 210 may refer to sub-types 250 that include a history, a scenario, a fact, an overview, and a summary. Action knowledge 220 may refer to sub-types 260 that include a strategy, a procedure, a rule, a principle, an order, a law, a comment on law, and a checklist. Explanation knowledge 230 may refer to sub-types 270 that include an example, an intention, a reflection, an explanation of why or what, and an argumentation. Resource knowledge 240 may refer to sub-types 280 that include a reference, a document reference, and an archival reference.

Dependencies between structural elements may be described by relations when assembling the structural elements at one aggregation level. A relation may be used to describe the natural, subject-taxonomic relation between the structural elements. A relation may be directional or non-directional. A directional relation may be used to indicate that the relation between structural elements is true only in one direction. Directional relations should be followed. Relations may be divided into two categories: subject-taxonomic and non-subject taxonomic.

Subject-taxonomic relations may be further divided into hierarchical relations and associative relations. Hierarchical relations may be used to express a relation between structural elements that have a relation of subordination or superordination. For example, a hierarchical relation between knowledge items A and B exists if B is part of A. Hierarchical relations may be divided into two categories: the part/whole relation (i.e., “has part”) and the abstraction relation (i.e., “generalizes”). For example, the part/whole relation “A has part B” describes that B is part of A. The abstraction relation “A generalizes B” implies that B is a specific type of A (e.g., an aircraft generalizes a jet or a jet is a specific type of aircraft).

Associative relations may be used to refer to a kind of relation of relevancy between two structural elements. Associative relations may help a user obtain a better understanding of facts associated with the structural elements. Associative relations describe a manifold relation between two structural elements and are mainly directional (i.e., the relation between structural elements is true only in one direction). Examples of associative relations, described below, include “determines,” “side-by-side,” “alternative to,” “opposite to,” “precedes,” “context of,” “process of,” “values,” “means of,” and “affinity.”

The “determines” relation describes a deterministic correlation between A and B (e.g., B causally depends on A). The “side-by-side” relation may be viewed from a spatial, conceptual, theoretical, or ontological perspective (e.g., A side-by-side with B is valid if both knowledge objects are part of a superordinate whole). The side-by-side relation may be subdivided into relations, such as “similar to,” “alternative to,” and “analogous to.” The “opposite to” relation implies that two structural elements are opposite in reference to at least one quality. The “precedes” relation describes a temporal relationship of succession (e.g., A occurs in time before B (and not that A is a prerequisite of B)). The “context of” relation describes the factual and situational relationship on a basis of which one of the related structural elements may be derived. An “affinity” between structural elements suggests that there is a close functional correlation between the structural elements (e.g., there is an affinity between books and the act of reading because reading is the main function of books).

Non Subject-Taxonomic relations may include the relations “prerequisite of” and “belongs to.” The “prerequisite of” and the “belongs to” relations do not refer to the subject-taxonomic interrelations of the knowledge to be imparted. Instead, these relations refer to progression of the course in the learning environment (e.g., as the user traverses the course). The “prerequisite of” relation is directional whereas the “belongs to” relation is non-directional. Both relations may be used for knowledge items 140 that cannot be further subdivided. For example, if the size of a screen is too small to display the entire content on one page, the page displaying the content may be split into two pages that are connected by the relation “prerequisite of.”

Another type of metadata is competencies. Competencies may be assigned to structural elements, such as, for example, a sub-course 120 or a learning unit 130. The competencies may be used to indicate and evaluate the performance of a user as the user traverses the course material. A competency may be classified as a cognitive skill, an emotional skill, a sensory motor skill, or a social skill.

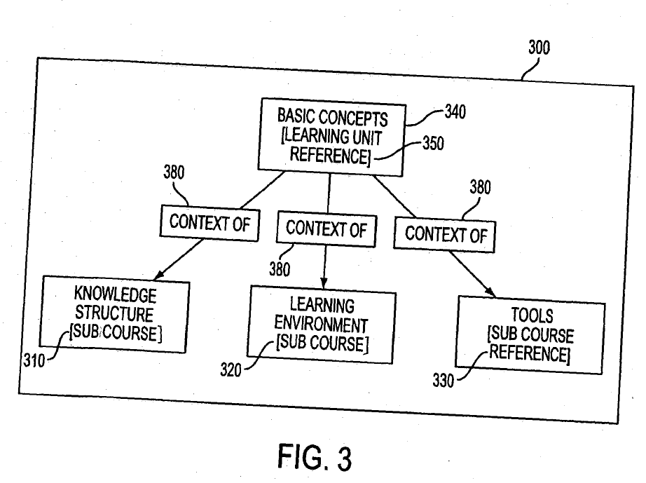

The content structure associated with a course may be represented as a set of graphs. A structural element may be represented as a node in a graph. Node attributes are used to convey the metadata attached to the corresponding structural element (e.g., a name, a knowledge type, a competency, and/or a media type). A relation between two structural elements may be represented as an edge. For example, FIG. 3 shows a graph 300 for a course. The course is divided into four structural elements or nodes (310, 320, 330, and 340): three sub-courses (e.g., knowledge structure, learning environment, and tools) and one learning unit (e.g., basic concepts).

A node attribute 350 of each node is shown in brackets (e.g., the node labeled “Basic concepts” has an attribute that identifies it as a reference to a learning unit). In addition, an edge 380 expressing the relation “context of” has been specified for the learning unit with respect to each of the sub-courses. As a result, the basic concepts explained in the learning unit provide the context for the concepts covered in the three sub-courses.

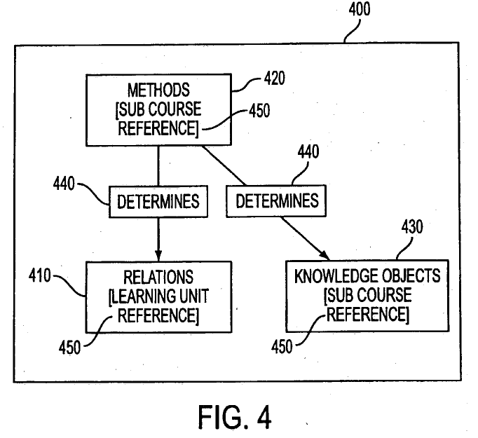

FIG. 4 shows a graph 400 of the sub-course “Knowledge structure” 310 of FIG. 3. In this example, the sub-course “Knowledge structure” is further divided into three nodes (410, 420, and 430): a learning unit (e.g., on relations) and two sub-courses.(e.g., covering the topics of methods and knowledge objects). The edge 440 expressing the relation “determines” is provided between the structural elements (e.g., the sub-course “Methods” determines the sub-course “Knowledge objects” and the learning unit “Relations”). In addition, the attribute 450 of each node is shown in brackets (e.g., nodes “Methods” and “Knowledge objects” have the attribute identifying them as references to other sub-courses; node “Relations” has the attribute of being a reference to a learning unit).

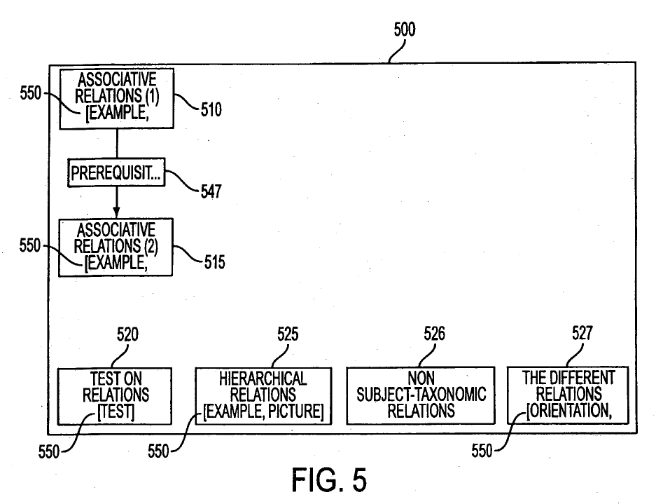

FIG. 5 shows a graph 500 for the learning unit “Relations” 410 shown in FIG. 4. The learning unit includes six nodes (510, 515, 520, 525, 526, 527): six knowledge items (i.e., “Associative relations (1)”, “Associative relations (2)”, “Test on relations”, “Hierarchical relations”, “Non subject-taxonomic relations”, and “The different relations”). An edge 547 expressing the relation “prerequisite” has been provided between the knowledge items “Associative relations (1)” and “Associative relations (2).” In addition, attributes 550 of each node are specified in brackets (e.g., the node “Hierarchical relations” includes the attributes “Example” and “Picture”).

Electronic Learning Strategies

The above-described content aggregation and structure associated with a course does not automatically enforce any sequence that a user may use to traverse the content associated with the course. As a result, different sequencing rules may be applied to the same course structure to provide different paths through the course. The sequencing rules applied to the knowledge structure of a course are learning strategies. The learning strategies may be used to pick specific structural elements to be suggested to the user as the user progresses through the course. The user or supervisor (e.g., a tutor) may select from a number of different learning strategies while taking a course. In turn, the selected learning strategy considers both the requirements of the course structure and the preferences of the user.

In a traditional classroom, a teacher determines the learning strategy that is used to learn course material. For example, in this context the learning progression may start with a course orientation, followed by an explanation (with examples), an action, and practice. Using the ELS and methods described herein, a user may choose between one or more learning strategies to determine which path to take through an electronic course. As a result, progressions of different users through the course may differ.

Learning strategies may be created using macro-strategies and micro-strategies. A user may select from a number of different learning strategies when taking a course. The learning strategies are selected at run time of the presentation of course content to the user (and not during the design of the knowledge structure of the course). As result, course authors are relieved from the burden of determining a sequence or an order of presentation of the course material. Instead, course authors may focus on structuring and annotating the course material. In addition, authors are not required to apply complex rules or Boolean expressions to domain models thus minimizing the training necessary to use the system. Furthermore, the course material may be easily adapted and reused to edit and create new courses.

Macro-strategies are used in learning strategies to refer to the coarse-grained structure of a course (i.e., the organization of sub-courses 120 and learning units 130). The macro-strategy determines the sequence that sub-courses 120 and learning units 130 are presented to the user. Basic macro-strategies include “inductive” and “deductive,” which allow the user to work through the course from the general to the specific or the specific to the general, respectively. Other examples of macro-strategies include “goal-based, top-down,” “goal-based, bottom-up,” and “table of contents.”

Goal-based, top-down follows a deductive approach. The structural hierarchies are traversed from top to bottom. Relations within one structural element are ignored if the relation does not specify a hierarchical dependency. Goal-based bottom-up follows an inductive approach by doing a depth first traversal of the course material. The table of contents simply ignores all relations.

Micro-strategies, implemented by the learning strategies, target the learning progression within a learning unit. The micro-strategies determine the order that knowledge items of a learning unit are presented. Micro-strategies refer to the attributes describing the knowledge items. Examples of micro-strategies include “orientation only”, “action oriented”, “explanation-oriented”, and “table of contents”).

The micro-strategy “orientation only” ignores all knowledge items that are not classified as orientation knowledge. The “orientation only” strategy may be best suited to implement an overview of the course. The micro-strategy “action oriented” first picks knowledge items that are classified as action knowledge. All other knowledge items are sorted in their natural order (i.e., as they appear in the knowledge structure of the learning unit). The micro-strategy “explanation oriented” is similar to action oriented and focuses on explanation knowledge. Orientation oriented is similar to action oriented and focuses on orientation knowledge. The micro-strategy “table of contents” operates like the macro-strategy table of contents (but on a learning unit level).

In one implementation, no dependencies between macro-strategies and micro-strategies exist. Therefore, any combination of macro and micro-strategies may be used when taking a course.

Course Configuration

The structure of a course is made up of graphs of the structural elements. A navigation tree may be determined from the graphs by applying a selected learning strategy to the graphs. The navigation tree may be used to navigate a path through the course for the user. Only parts of the navigation tree may be displayed to the user at the learning portal based on the position of the user within the course.

As described above, learning strategies are applied to static course structure including structural elements (nodes), metadata (attributes), and relations (edges). This data is created when the course structure is determined (e.g., by a course author). Once the course structure is created, the course player processes the course structure using a strategy to present the material to the user at the learning portal. The course may be custom-tailored to a user's needs either before or during presentation of the materials.

Architecture

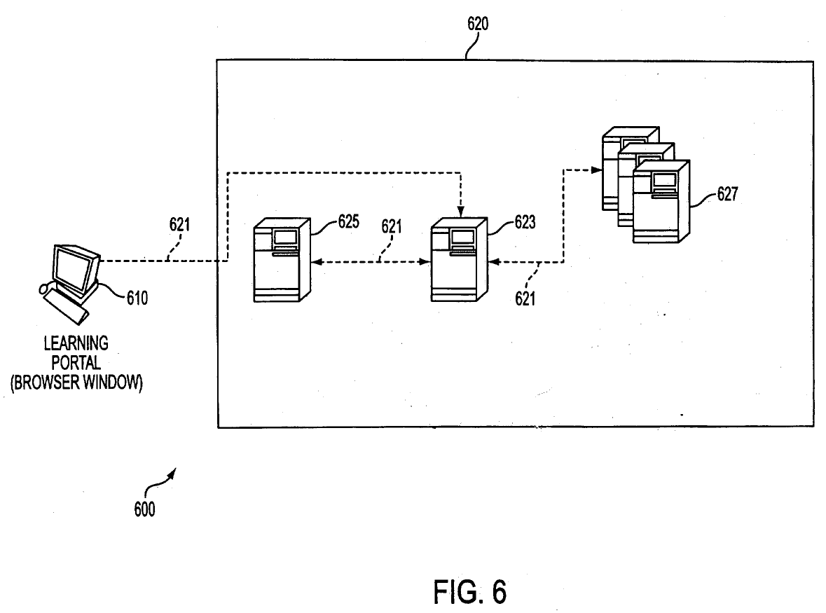

As shown in FIG. 6 an electronic learning architecture 600 may include a learning station 610 and a learning system 620. The user may access course material using a learning station 610 (e.g., a learning portal). The learning station 610 may be implemented using a work station, a computer, a portable computing device, or any intelligent device capable of executing instructions and connecting to a network. The learning station 610 may include any number of devices and/or peripherals (e.g., displays, memory/storage devices, input devices, interfaces, printers, communication cards, and speakers) that facilitate access to and use of course material.

The learning station 610 may execute any number of software applications, including an application that is configured to access, interpret, and present courses and related information to a user. The software may be implemented using a browser, such as, for example, Netscape communicator, Microsoft's Internet explorer, or any other software application that may be used to interpret and process a markup language, such as HTML, SGML, DHTML, or XML.

The browser also may include software plug-in applications that allow the browser to interpret, process, and present different types of information. The browser may include any number of application tools, such as, for example, Java, Active X, JavaScript, and Flash.

The browser may be used to implement a learning portal that allows a user to access the learning system 620. A link 621 between the learning portal and the learning system 620 may be configured to send and receive signals (e.g., electrical, electromagnetic, or optical). In addition, the link may be a wireless link that uses electromagnetic signals (e.g., radio, infrared, to microwave) to convey information, between the learning station and the learning system.

The ELS may include one or more servers. As shown in FIG. 6, the learning system 620 includes a learning management system 623, a content management system 625, and an administration management system 627. These systems may be implemented using one or more servers, processors, or intelligent network devices/machines.

The administration system may be implemented using a server, such as, for example, the SAP R/3 4.6C+LSO Add-On. The administration system may include a database of user accounts and course information. For example, the user account may comprise a profile containing demographic data about the user (e.g., a name, an age, a sex, an address, a company, a school, an account number, and a bill) and his/her progress through the course material (e.g., places visited, tests completed, skills gained, knowledge acquired, and competency using the material). The administration system also may provide additional information about courses, such as the courses offered, the author/instructor of a course, and the most popular courses.

The content management system may include a learning content server. The learning content server may be implemented using a WebDAV server. The learning content server may include a content repository. The content repository may store course files and media files that are used to present a course to a user at the learning station. The course files may include the structural elements that make up a course and may be stored as XML files (or may have any other type of format). The media files may be used to store the content that is included in the course and assembled for presentation to the user at the learning station.

The learning management system may include a content player. The content player may be implemented using a server, such as, an SAP J2EE Engine. The content player is used to obtain course material from the content repository. The content player also applies the learning strategies to the obtained course material to generate a navigation tree for the user. The navigation tree is used to suggest a route through the course material for the user and to generate a presentation of course material to the user based on the learning strategy selected by the user.

The learning management system also may include an interface for exchanging information with the administration system. For example, the content player may update user account information as the user progresses through the course material via the interface to the administration system.

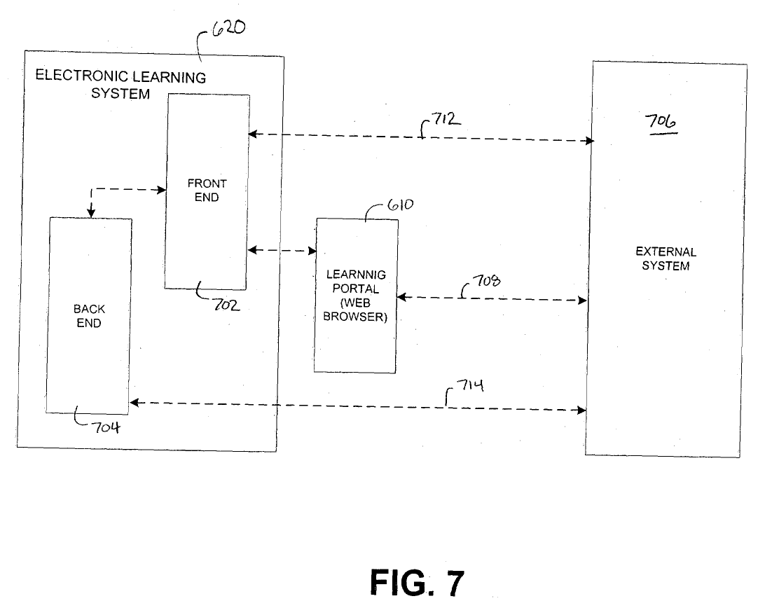

Referring to FIG. 7, electronic learning system 620 includes a front end 702 and a back end 704. Front end 702 and back end 704 may be implemented using the architecture of FIG. 6, and may include one or more servers, computers, and/or other machines. Front end 702 mediates access to course content from one or more external systems. Back end 704 manages and updates information, such as a course catalog, associated with the course content.

Through front end 702 and back end 704, the ELS is able to offer content hosted by external systems. An external system may be a system that is not part of the ELS. For example, an external system may be located on a different network than the ELS and/or may be accessible via, e.g., the Internet or a wide area network (WAN). External systems include, but are not limited to, other electronic learning systems, Web-based training systems, and virtual classrooms.

Content of an externally hosted electronic course is stored on server(s) of the external system that hosts the courses. During course processing, this content is accessed via a Web server, which is part of the external system and which acts as content player for remote users.

Referring again to FIG. 7, there are three communication channels between external system 706 and ELS 620. These three channels include channel 708 between external system 706 and a Web browser 710 on learning portal 610, channel 712 between front end 702 and external system 706, and channel 714 between back end 704 and external system 706.

Channel 708 supports communication that takes place during access of an externally hosted course, i.e., while the course is being presented. Channel 708 may be a standard Internet Protocol (IP) connection, which may be opened by front end 702 when an externally-hosted course is launched.

Channel 712 supports communications to register a user with an externally-hosted course and to launch the course. After course launch, the user's Web browser takes over communication with the external system.

Channel 714 supports communications between back end 704 and external system 706. The communication channel may remain open while ELS 620 is in operation.

Communications over all of the channels between the ELS and external system 706 may be encrypted to ensure confidentiality of transferred data.

Back end 704 creates and maintains a database containing information about each external system that can interface to the ELS. This information may include, but is not limited to, the name and address of a learning service provider (LSP) that hosts the external course, a contact person at the LSP, a customer identifier (ID) of the LSP, and a list of services offered by the external system to users of the ELS.

Back end 704 also maintains a course catalog for courses hosted by the external system. A course catalog describes material covered in a course provided by the external system. For example, a course catalog may contain a table of contents and other useful information about the course.

In this embodiment, each course catalog is comprised sets of metadata (one set for each course) that are organized hierarchically. Back end 704 obtains metadata for a course catalog from an external system, stores the metadata, and makes the course catalog available to front end 702 (and thus to users of the ELS). Back end 704 may obtain the course metadata periodically or each time the course catalog is updated. In this embodiment, the course catalog is represented as an XML-file that follows the XML Schema Definition (XSD) for training catalogues.

Back end 704 uses channel 714 to obtain the course metadata from external system 706. For example, an administrator may receive notification that an updated course catalog has arrived at back end 704. The administrator may log onto a computer at back end 704 and use training catalog utilities to update the course catalog. In this embodiment, such data transfer is asynchronous and both communication parties (the external system and the ELS) agree on the format and structure of the course metadata beforehand.

Front end 702 obtains a description of electronic courses provided by an external system from back end 704, presents the description to a user via learning portal 610, determines which course(s) the user has selected, and communicates with the external system to access the requested course(s). The communications include a series of commands and responses, which contain identification and control information to register for, enroll in, and launch the course(s).

Front end 702 also updates training participation documents at the end of a course via channel 712. Training participation documents contain information about user activity vis-à-vis the electronic course, such as the amount of time spent viewing the course, the course materials viewed, and so on. The training documents may be stored in a database (not shown) on ELS 620 or elsewhere.

Front end 702 performs the following functions in order to obtain access to an electronic course hosted by an external system: registering new users with the external system, enrolling the user in the electronic course, launching the electronic course on the external system, and tracking user activity through the electronic course on the external system. These functions may be implemented by sending HTTP POST commands containing the appropriate information as an XML document using simple object access protocol (SOAP). Secure Sockets Layer (SSL) may be used for data transmission.

The ELS expects the external system to acknowledge each command by either returning requested data or a message indicating whether the service request succeeded or failed.

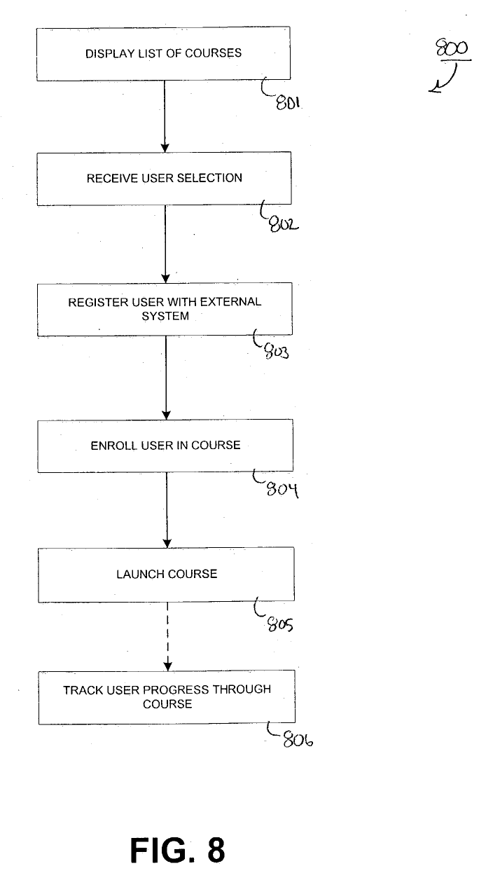

FIG. 8 shows a process 800 that is performed by front end 702 to access an electronic course hosted by external system 706. Process 800 displays (801), on learning portal 610, a list of courses that are available through the ELS. The list of courses may be obtained by reading course catalog metadata from back end 704. Process 800 receives (802) a user selection of a course hosted by external system 706.

If the user is new to the external system, process 800 registers the user with the external system. The registration process may be skipped if the user is already registered with the external system. This may be determined by examining the user's profile and/or data stored in back end 704.

Process 800 registers (803) the user by sending a command to the external system. The command may be an HTTP command, which includes XML code and which is transmitted via SOAP.

External system 706 may require specific information to complete registration. This information may be included in the command. In this embodiment, the information required by external system includes an account name and password of the provider of the ELS, a unique handle to identify the user, the first and last name of the user, and the user's e-mail address.

Process 800 may retrieve the necessary information from back end 704 and/or from a profile stored for the user in the ELS. Process 800 uses the information to generate the registration command. An example of a registration command that may be generated is shown below.

```
<SOAP-ENV:Body>
      <sapns:registerLearner
        xmlns:sapns=“<SAP name space specification>”
        xmlns:SOAP-ENV=“http://schemas.xmlsoap.org/soap/
        envelope/”
        SOAP-ENV:encodingStyle=“http://schemas.xmlsoap.org/soap/
        encoding/”>
        <account>
          <sapns:username>account</sapns:username>
          <sapns:password>password</sapns:password>
        </account>
        <userLogin xmlns:xsi=“http://www.w3.org/1999/
        XMLSchema-instance”
                xsi:type=“xsd:string”>
          01P99240902
        </userLogin>
        <firstName xmlns:xsi=“http://www.w3.org/1999/
        XMLSchema-instance”
                xsi:type=“xsd:string”>
          Jack
        </firstName>
        <lastName xmlns:xsi=“http://www.w3.org/1999/
        XMLSchema-instance”
                xsi:type=“xsd:string”>
          Jones
        </lastName>
        <emailAddress xmlns:xsi=“http://www.w3.org/1999/
        XMLSchema-instance”
                xsi:type=“xsd:string”>
          jones@xyz.com
        </emailAddress>
      </sapns:registerLearner>
</SOAP-ENV:Body>
```

Process 800 sends the registration command via communication channel 712. Process 800 expects to receive a response to the registration command over the same channel. The response may indicate whether registration succeeded or failed. If registration failed, the response may include a reason for the failure. In this case, process 800 may notify the user that the electronic course is unavailable and/or prompt the user for additional information, as needed.

After registration has been completed successfully, process 800 enrolls (804) the user in the electronic course. Process 800 enrolls the user in the course by sending a command to the external system. As above, the command may be an HTTP command containing XML code and transmitted via SOAP.

External system 706 may require specific information to complete enrollment. This information may be included in the command. In this embodiment, this information may include an account name and password of the provider of the ELS, a unique handle to identify the user, the first and last name of the user, the user's e-mail address, and the identity of the course that the user wants to take.

Process 800 may retrieve the necessary information from back end 704 and/or from a profile stored for the user in the ELS. Process 800 uses the information to generate an enrollment command. An example of an enrollment command that may be generated is shown below.

```
<SOAP-ENV:Body>
      <sapns:enrollInCourses
        xmlns:sapns=“<SAP name space specification>”
        xmlns:SOAP-ENV=“http://schemas.xmlsoap.org/soap/
        envelope/”
        SOAP-ENV:encodingStyle=“http://schemas.xmlsoap.org/
        soap/encoding/”>
        <account>
          <sapns:username>account</sapns:username>
          <sapns:password>password</sapns:password>
        </account>
        <userLogin xmlns:xsi=“http://www.w3.org/1999/
        XMLSchema-instance”
                xsi:type=“xsd:string”>
          01P99240902
        </userLogin>
        <firstName xmlns:xsi=“http://www.w3.org/1999/
        XMLSchema-instance”
                xsi:type=“xsd:string”>
          Jack
        </firstName>
        <lastName xmlns:xsi=“http://www.w3.org/1999/
        XMLSchema-instance”
              xsi:type=“xsd:string”>
          Jones
        </lastName>
        <emailAddress xmlns:xsi=“http://www.w3.org/1999/
        XMLSchema-instance”
                xsi:type=“xsd:string”>
          Jones@xyz.com
        </emailAddress>
        <coursesList xmlns:enc=“http://schemas.xmlsoap.org/soap/
        encoding/”
                xmlns:xsi=“http://www.w3.org/1999/
                XMLSchema-instance”
                xsi:type=“enc:Array”
                enc:arrayType=“xsd:string[1]”>
          <Item>be001</Item>
        </coursesList>
      </sapns:enrollInCourses>
</SOAP-ENV:Body>
```

Process 800 sends the enrollment command via communication channel 712. Process 800 expects to receive a response to the enrollment command over the same channel. The response may indicate whether enrollment succeeded or failed. If enrollment failed, the response may include a reason for the failure. In this case, process 800 may notify the user that the electronic course is unavailable and/or prompt the user for additional information, as needed.

After enrollment has been completed successfully, process 800 launches the electronic course. Process 800 launches (805) the course by sending a command to the external system that hosts the course. As above, the command may be an HTTP command containing XML code transmitted via SOAP.

External system 706 may require specific information to be in the launch command. In this embodiment, this information may include an account name and password of the provider of the ELS, a unique handle to identify the user, the first and last name of the user, the user's e-mail address, and the identity of the course to launch.

As above, process 800 may retrieve the necessary information from back end 704 and/or from a profile stored for the user in the ELS. Process 800 uses the information to generate the launch command. An example of a launch command that may be generated is shown below.

```
<SOAP-ENV:Body>
      <sapns:launchCourse
        xmlns:sapns=“<SAP name space specification>”
        xmlns:SOAP-ENV=“http://schemas.xmlsoap.org/soap/
        envelope/”
        SOAP-ENV:encodingStyle=“http://schemas.xmlsoap.org/
        soap/encoding/”>
        <account>
          <sapns:username>account</sapns:username>
          <sapns:password>password</sapns:password>
        </account>
        <userLogin xmlns:xsi=“http://www.w3.org/1999/
        XMLSchema-instance”
                xsi:type=“xsd:string”>
          01P99240902
        </userLogin>
        <courseName xmlns:enc=“http://schemas.xmlsoap.org/soap/
        encoding/”
                xmlns:xsi=“http://www.w3.org/1999/
                XMLSchema-instance”
                xsi:type=“xsd:string”>
          be001
        </courseName>
      </sapns:launchCourse>
</SOAP-ENV:Body>
```

Process 800 sends the enrollment command via communication channel 712. Process 800 expects to receive a response to the enrollment command over the same channel. The response may be an HTTP REDIRECT command that directs the ELS to the location of the course. Alternatively, the response may be a uniform resource locator (URL), sent via e-mail to the user, that links to the course. In either case, once the course has launched, communications are transferred to browser 710. Communications, including display of course content, are then exchanged between browser 710 and external system 706.

An administrator, or other user of the ELS, may need to obtain the user's activity records on the external system. Process 800 provides a user tracking service for this purpose. Briefly, process 800 transmits a command to external system 706 requesting tracking information on a user. External system 706 responds to the tracking command by providing the ELS with a report showing the users activity on the external system. The report may include, e.g., a percentage of material from an electronic course on external system 706 that has been viewed, a test score associated with material from the electronic course, and an amount of time spent viewing material in the electronic course. Transmission of the report may be over communication channel 712 and via front end 702.

In more detail, process 800 tracks (806) the user by sending a command to the external system. As above, the command may be an HTTP command which contain XML code and which is transmitted via SOAP.

External system 706 may require specific information to provide the tracking information. This information is included in the command. In this embodiment, this information may include an account name and password of the provider of the ELS, a unique handle to identify the user, and a list of courses on which to provide a report.

Process 800 may retrieve the necessary information from back end 704 and/or from a profile stored for the user in the ELS. Process 800 uses the information to generate a tracking command. An example of a tracking command that may be generated is shown below.

```
<SOAP-ENV:Body>
      <sapns:getActivityRecord
        xmlns:sapns=“<SAP name space specification>”
        xmlns:SOAP-ENV=“http://schemas.xmlsoap.org/soap/
        envelope/”
        SOAP-ENV:encodingStyle=“http://schemas.xmlsoap.org/
        soap/encoding/”>
        <account>
          <sapns:username>account</sapns:username>
          <sapns:password>password</sapns:password>
        </account>
        <usersList xmlns:enc=“http://schemas.xmlsoap.org/soap/
        encoding/”
                xmlns:xsi=“http://www.w3.org/1999/
                XMLSchema-instance”
                xsi:type=“enc:Array”
                enc:arrayType=“xsd:string[1]”>
          <Item>01P99240902</Item>
        </usersList>
        <userLogin xmlns:xsi=“http://www.w3.org/1999/
        XMLSchema-instance”
                xsi:type=“xsd:string”>
          01P99240902
        </userLogin>
        <coursesList xmlns:enc=“http://schemas.xmlsoap.org/soap/
        encoding/”
                xmlns:xsi=“http://www.w3.org/1999/
                XMLSchema-instance”
                xsi:type=“enc:Array”
                enc:arrayType=“xsd:string[1]”>
          <Item>be001</Item>
        </coursesList>
      </sapns:getActivityRecord>
</SOAP-ENV:Body>
```

As noted, in this embodiment, the expected response to the tracking command includes, but is not limited to, a percentage of material from an electronic course on external system 706 that has been viewed, a test score associated with material from the electronic course, and an amount of time spent viewing material in the electronic course. The format of the report may vary. The report may be displayed on one or more computers of ELS 620.

Other Embodiments

The ELS is not limited to use with the hardware and software of FIGS. 1 to 8; it may find applicability in any computing or processing environment and with any type of machine that is capable of running machine-readable instructions, such as a computer program.

The ELS may be implemented in hardware, software, or a combination of the two. The system may be implemented in computer programs executing on programmable computers that each include a processor, a storage medium readable by the processor (including volatile and non-volatile memory and/or storage elements.

Each such program may be implemented in a high level procedural or object-oriented programming language to communicate with a computer system. However, the programs can be implemented in assembly or machine language. The language may be a compiled or an interpreted language.

Each computer program may be stored on a storage medium or device (e.g., CD-ROM, hard disk, or magnetic diskette) that is readable by a general or special purpose programmable computer for configuring and operating the computer when the storage medium or device is read by the computer to implement the ELS. The ELS may also be implemented as a computer-readable storage medium, configured with a computer program, where, upon execution, instructions in the computer program cause the computer to implement ELS functions.

The invention is not limited to the embodiments set forth herein. For example, the blocks in FIG. 8 may be rearranged and/or one or more of the blocks may be omitted. The features described above may be used with systems other than the ELS described herein. The commands and protocols used herein are merely representative; others may be used. The features shown in FIGS. 1 to 8 can be modified to accommodate alternative systems, networks, and protocols.

Other embodiments are also within the scope of the following claims.

1. An electronic learning system (ELS) that provides access to an electronic course that is hosted by an external system that is not part of the ELS, the ELS comprising:
a front end that exchanges communications with the external system to obtain access to the electronic course;
a learning portal that runs software to view the electronic course; and
a back end that stores information that relates to the electronic course.

2. The ELS of claim 1, wherein the communications comprise a register command that is transmitted from the front end to the external system to register a user of the ELS with the external system.

3. The ELS of claim 1, wherein the communications comprise an enroll command that is transmitted from the front end to the external system to enroll a user of the ELS in the electronic course.

4. The ELS of claim 1, wherein the communications comprise a launch command that is transmitted from the front end to the external system to start the electronic course.

5. The ELS of claim 1, wherein the communications comprise a track command that is transmitted from the front end to the external system to track user activity vis-à-vis the electronic course.

6. The ELS of claim 5, wherein the communications comprise a response that is transmitted from the external system to the front end following receipt of the track command by the external system.

7. The ELS of 6, wherein the response comprises at least one of the following: a percentage of material from the electronic course that has been viewed, a test score associated with material from the electronic course, and an amount of time spent viewing material in the electronic course.

8. The ELS of claim 1, wherein the communications comprise commands transmitted from the ELS to the external system and replies from the external system to the ELS.

9. The ELS of claim 8, wherein the commands are transmitted in accordance with simple object access protocol (SOAP).

10. The ELS of claim 1, wherein the information comprises metadata, and the back end obtains the metadata from the external system.

11. The ELS of claim 10, wherein the metadata comprises a course catalog for the electronic course, the course catalog containing a description of material in the electronic course.

12. The ELS of claim 1, wherein the learning portal, the front end, and the back end are implemented on a single computer.

13. The ELS of claim 1, wherein the learning portal, the front end, and the back end are implemented on multiple computers.

14. An electronic learning system (ELS) that incorporates an electronic course that is hosted by an external system that is not part of the ELS, the ELS comprising:
a front end that issues commands to the external system to obtain access to the electronic course, the commands comprising:
a register command to register with the external system;
an enroll command to enroll in the electronic course; and
a launch command to launch the electronic course.

15. The ELS of claim 14, wherein the commands further comprise a track command to track progress with respect to the electronic course.

16. The ELS of claim 15, wherein the front end receives a response to the track command, the response comprising a percentage of material from the electronic course that has been viewed, a test score associated with material from the electronic course, and an amount of time spent viewing material in the electronic course.

17. The ELS of claim 14, further comprising:
a back end that retrieves metadata from the external system and that updates a course catalog using the metadata, the course catalog comprising a description of material associated with the electronic course.

18. The ELS of claim 14, wherein the commands are transmitted in accordance with simple object access protocol (SOAP).

19. The ELS of claim 14, wherein the ELS accesses the external system over a network, the commands being sent from the ELS to the external system over the network.

20. The ELS of claim 19, wherein the network comprises the Internet.

21. An electronic learning system (ELS) comprising:
a front end to mediate access to an electronic course that is hosted by an external system that is not part of the ELS, the front end interacting with the external system through a series of commands that contain identification and control information for use by the external system, the front end receiving responses to the commands including a response relating to progress through the electronic course; and
a back end to maintain information on the ELS about the electronic course.

22. The ELS of claim 21, wherein the back end obtains metadata from the external system, the metadata containing a description of information in the electronic course, the back end storing the metadata in memory on the ELS.

23. The ELS of claim 21, further comprising:
a learning portal that runs a Web browser to present the electronic course.

24. The ELS of claim 21, wherein the commands comprise at least one of:
a register command that is transmitted from the front end to the external system to register a user of the ELS with the external system;
an enroll command that is transmitted from the front end to the external system to enroll a user of the ELS in the electronic course;
a launch command that is transmitted from the front end to the external system to start the electronic course; and
a track command that is transmitted from the front end to the external system to track user activity vis-à-vis the electronic course.

25. The ELS of claim 21, wherein the commands are transmitted according to the simple object access protocol (SOAP).

26. A machine-readable medium that stores executable instructions to access, via an electronic learning system (ELS), an electronic course hosted by an external system that is not part of the ELS, the instructions causing a machine to:
communicate with the external system via a series of commands to register with the external system, enroll in the electronic course, and launch the electronic course; and
maintain a database of information associated with the electronic course.

27. The machine-readable medium of claim 26, wherein the commands further comprise a track command to track progress through the electronic course.

28. The machine-readable medium of claim 26, wherein the commands are transmitted in accordance with simple object access protocol (SOAP).

29. The machine-readable medium of claim 26, wherein maintaining the database of information comprises:
receiving metadata from the electronic course; and
updating the database in accordance with the metadata.

30. The machine-readable medium of claim 29, wherein the database comprises a course catalog that includes information about the electronic course.

31. The machine-readable medium of claim 26, wherein maintaining the database of information comprises storing information about the external system.

32. The machine-readable medium of claim 26, wherein communicating with the external system comprises receiving responses to the commands, at least one of the responses comprising at least one of the following: a percentage of material from the electronic course that has been viewed, a test score associated with material from the electronic course, and an amount of time spent viewing material in the electronic course.

33. An electronic learning system (ELS) that provides access to an electronic course that is hosted by an external system that is not part of the ELS, the ELS comprising:
means for exchanging communications with the external system to obtain access to the electronic course;
means for presenting the electronic course; and
means for collecting information that relates to the electronic course.

34. The ELS of claim 33, wherein the means for exchanging comprises one or more servers to mediate access to the electronic course, the one or more servers exchanging communications with the external system through a series of commands that contain identification and control information for use by the external system, the one or more servers receiving responses to the commands, the responses comprising a response relating to progress through the electronic course and a response providing the ELS with access to the electronic course.

35. A network comprising:
a first ELS that hosts an electronic course; and
a second ELS that accesses the electronic course over a network via a series of commands and responses, the series of commands and responses comprising:
a register command transmitted from the second ELS to the first ELS to register with the first ELS;
an enroll command transmitted from the second ELS to the first ELS to enroll in the electronic course;
a launch command transmitted from the second ELS to the first ELS to launch the electronic course; and
a response to the launch command, the response being transmitted from the first ELS to the second ELS following receipt of the launch command by the first ELS, the response making accessible material from the electronic course to the second ELS.

36. The network of claim 35, wherein the response comprises a hypertext transfer protocol (HTTP) command that directs the second ELS to the material.

37. The network of claim 35, wherein the response comprises a uniform resource locator (URL) that can be used to link to the material.
